(19) United States
(12) Patent Application Publication
(10) Pub. No.: US 2015/0178632 A1
(43) Pub. Date: Jun. 25, 2015

(54) METHOD AND APPARATUS FOR IDENTIFYING INITIATION ITEMS

(71) Applicant: Tencent Technology (Shenzhen) Company Limited, Shenzhen (CN)

(72) Inventors: Qikang Fu, Shenzhen (CN); Junxiang Luo, Shenzhen (CN)

(73) Assignee: Tencent Technology (Shenzhen) Company Limited, Shenzhen (CN)

(21) Appl. No.: 14/639,792

(22) Filed: Mar. 5, 2015

Related U.S. Application Data
(63) Continuation of application No. PCT/CN2013/082837, filed on Sep. 3, 2013.

(30) Foreign Application Priority Data
Sep. 7, 2012 (CN) 201210330208.0

(51) Int. Cl. G06N 5/04; G06N 7/02

(52) U.S. Cl. CPC G06N 5/047; G06N 7/02

(57) ABSTRACT

The present invention relates to a method and apparatus for identifying initiation items. The method for identifying an initiation item comprises: obtaining a description string of the initiation item to be identified; matching the obtained description string of the initiation item to be identified with a pre-stored fuzzy matching pattern for the description string of the initiation item in accordance with a preset matching rule to determine whether there is a successful match; and if there is a successful match, identifying the obtained description string of the initiation item to be identified with the matched fuzzy matching pattern. In accordance with the embodiments of the present invention, the identification of initiation items can be enhanced, the size of the configuration file storing the initiation items can be reduced, and the speed of reading the initiation items can be increased.

### CROSS-REFERENCE TO RELATED APPLICATIONS

This application is a continuation of International Patent Application No. PCT/CN2013/082837, entitled “Method and Apparatus for Identifying Initiation Items,” filed on Sep. 3, 2013. This application claims the benefit and priority of Chinese Patent Application No. 201210330208.0, entitled “Method and Apparatus for Identifying Initiation Items,” filed on Sep. 7, 2012. The entire disclosures of each of the above applications are incorporated herein by reference.

### TECHNICAL FIELD

The present invention relates to information technologies, and more particularly to a method and apparatus for identifying initiation items.

### BACKGROUND

When a computer starts, various initiation items, such as application programs or dynamic-link libraries (DLLs), will be initiated, either in the foreground or the background. The self-initiation of the initiation items is convenient for the users. However, the same initiation item often has different names on different computers, which makes it difficult for users to identify initiation items.

There are three common methods for identifying initiation items. In accordance with the first method, information about the initiation item is sent to a cloud server, and the server searches for the initiation item to be identified, and sends back a description of the initiation item. In accordance with the second method, a local database is searched for an initiation item that matches with the initiation item to be identified, and the local database is periodically updated. The third method combines the first and the second method. Whichever method is employed, a database on the local computer or the server is searched. With the advancement of computers technologies, more and more software are being installed on computers. A typical computer may have hundreds of initiation items pre-installed; and there are literally millions of computer programs on the market. In order to identify the initiation items pre-installed on or added later to a computer, millions or more data items would need to be added to the database, which would put enormous stress on both the clients and the servers, and make it difficult to identify the initiation items.

### SUMMARY OF THE INVENTION

To address issues in the prior art, the embodiments of the present invention provide a method and apparatus for identifying initiation items.

In accordance with embodiments of the present invention, a method for identifying an initiation item is provided, the method comprises: obtaining a description string of the initiation item to be identified; matching the obtained description string of the initiation item to be identified with a pre-stored fuzzy matching pattern for the description string of the initiation item in accordance with a preset matching rule to determine whether there is a successful match; and if there is a successful match, identifying the obtained description string of the initiation item to be identified with the matched fuzzy matching pattern.

In accordance with embodiments of the present invention, an apparatus for identifying an initiation item is provided, the apparatus comprises: an acquisition module for obtaining a description string of the initiation item to be identified; and a determination module for matching the obtained description string of the initiation item to be identified with a pre-stored fuzzy matching pattern for the description string of the initiation item in accordance with a preset matching rule to determine whether there is a successful match; and, if there is a successful match, identifying the obtained description string of the initiation item to be identified with the matched fuzzy matching pattern.

In accordance with embodiments of the present invention, the obtained description string of the initiation item to be identified is matched with a pre-stored fuzzy matching pattern for the description string of the initiation item in accordance with a preset matching rule to determine whether there is a successful match; and if there is a successful match, the obtained description string of the initiation item to be identified is identified with the matched fuzzy matching pattern. Thus, various initiation items can be identified using one fuzzy matching pattern, which enhances the identification of the initiation items and speed up the matching of initiation items. The descriptions of the initiation items can be timely obtained to enhance user experiences. Furthermore, the size of the configuration file in the boot acceleration module storing the initiation items can be reduced, the speed of reading the initiation items can be increased, and accurate descriptions of the initiation items can be provided to users to help user keep necessary initiation items and remove initiation items with bad reviews.

### BRIEF DESCRIPTION OF THE DRAWINGS

To better illustrate the technical features of the embodiments of the present invention, various embodiments of the present invention will be briefly described in conjunction with the accompanying drawings.

FIG. 1 is an exemplary flowchart for a method for identifying initiation items in accordance with an embodiment of the present invention.

FIG. 2A is an exemplary flowchart for a method for identifying initiation items in accordance with another embodiment of the present invention.

FIG. 2B is an exemplary flowchart for a fuzzy matching method in accordance with another embodiment of the present invention.

FIG. 3 is an exemplary schematic diagram for an apparatus for identifying initiation items in accordance with yet another embodiment of the present invention.

### DESCRIPTION OF THE PREFERRED EMBODIMENTS

To better illustrate the purpose, technical feature, and advantages of the embodiments of the present invention, various embodiments of the present invention will be further described in conjunction with the accompanying drawings. In the following discussion, the term “client” may refer to, a client terminal device, which includes but is not limited to, a desktop computer, a laptop, a netbook, a tablet, a mobile phone, a multimedia TV and other electronic equipment, or a client side application program.

It should be noted that the various embodiments of the present invention are merely provided to illustrate the purpose, technical features, and functionalities of the present invention, and are not intended to limit the scope of the invention.

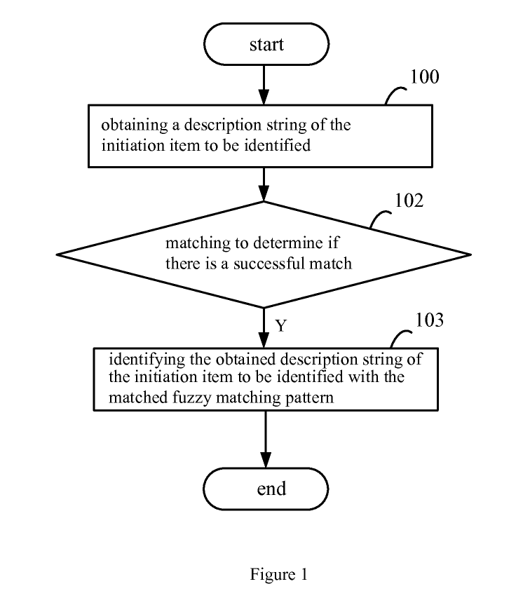

FIG. 1 is an exemplary flowchart for a method for identifying initiation items in accordance with an embodiment of the present invention. As shown in FIG. 1, the method for identifying an initiation item in this embodiment comprises steps 100-103:

Step 100: obtaining a description string of the initiation item to be identified.

In this step, the description string of the initiation item to be identified can include the initiation item name, and the executable file name for the initiation item. For example, the initiation item name can be GoogleUpdateTaskUserS-1-5-21-690938163-3349951645-2544307016-1003UA.job; and the executable file name for the initiation item can be Googleupdate.Exe.

Step 102: matching the obtained description string of the initiation item to be identified with a pre-stored fuzzy matching pattern for the description string of the initiation item in accordance with a preset matching rule to determine whether there is a successful match; and if there is a successful match, proceeding to step 103.

In this step, the wildcard characters include, for example, “*”, “?”, “#”, “@”, “<”, “>” and other special symbols. The pre-stored fuzzy matching pattern for the description string of the initiation item can include the following four patterns:

1) SV pattern: for example, for two different description strings of the same initiation item, “QQPCTray_v1” and “QQPCTray_v2”, S can be a string starting from the first character and ending with any character of “QQPCTray_v”, while V can be the remaining characters in the string. One of the SV patterns can be “QQPCTray_v*”, where * stands for any characters.

2) VS patterns: for example, for two different description strings of the same initiation item, “Old_QQPCTray” and “New_QQPCTray”, S can be a string starting from the first character and ending with any character of “QQPCTray”, while V can be the remaining characters in the string. One of the VS patterns can be “*_QQPCTray”, where * stands for any characters.

3) S1VS2 pattern: for example, for two different description strings of the same initiation item, “QQPCTray2009.exe” and “QQPCTray2010.exe”, S1 can be a string starting from the first character and ending with any character of “QQPCTray20”, S2 can be a string starting from the first character and ending with any character of “.exe”, while V can be the remaining characters in the string. One of the S1VS2 patterns can be “QQPCTray20*.exe”, wherein * stands for any characters.

4) V1SV2 pattern: for example, for two different description strings of the same initiation item, “Old_QQPCTray_v1” and “New_QQPCTray_v2”, S can be a string starting from the first character and ending with any character of “QQPCTray_v”; while V1 can be the remaining characters in the string before S, and V2 can be the remaining characters in the string after S. One of the V1SV2 patterns can be “*_QQPCTray_v*”, wherein * stands for any characters.

In the four patterns, S represents the identical portion of two different description strings of the same initiation item (not case-sensitive); V represents the different or variable portion of two different description strings of the same initiation item; and if there are multiple number of S or V, they will be indicated by appending a number, such as 51, S2. In implementation, the variable portion V of two different description strings of the same initiation item can also be represented using a special symbol, such as “*”, “?”, “#”, “@”, “<”, “>”. The variable portion V can also be an empty string, so that the SV and VS patterns can also be represented as V1SV2 pattern.

In accordance with a preset matching rule, the obtained description string of the initiation item to be identified is matched with all the fuzzy matching patterns discussed above. If the obtained description string of the initiation item to be identified matches with any of the fuzzy matching patterns above, then there is a successful match. On the other hand, if the obtained description string of the initiation item to be identified does not match with any of the fuzzy matching patterns above, then there is a match failure.

Step 103: if there is a successful match, identifying the obtained description string of the initiation item to be identified with the matched fuzzy matching pattern.

In this step, if the description string of the initiation item to be identified is “abc_QQPCTray_v2009”, and one of the fuzzy matching patterns is “*_QQPCTray_v*”, then the description string matches with the fuzzy matching pattern, and the description string of the initiation item to be identified “abc_QQPCTray_v2009” is identified by the matched fuzzy matching pattern “*_QQPCTray_v*”. In another words, the obtained description string of the initiation item to be identified “abcQQPCTray_v2009” belongs to a class that the fuzzy matching pattern “*_QQPCTray_v*” represents.

In accordance with this embodiment, the obtained description string of the initiation item to be identified is matched with a pre-stored fuzzy matching pattern for the description string of the initiation item in accordance with a preset matching rule to determine whether there is a successful match; and if there is a successful match, the obtained description string of the initiation item to be identified is identified with the matched fuzzy matching pattern. Thus, various initiation items can be identified using one fuzzy matching pattern, which enhances the identification of the initiation items and speed up the matching of initiation items. The descriptions of the initiation items can be timely obtained to enhance user experiences. Furthermore, the size of the configuration file in the boot acceleration module storing the initiation items can be reduced, the speed of reading the initiation items can be increased, and accurate descriptions of the initiation items can be provided to users to help user keep necessary initiation items and remove initiation items with bad reviews.

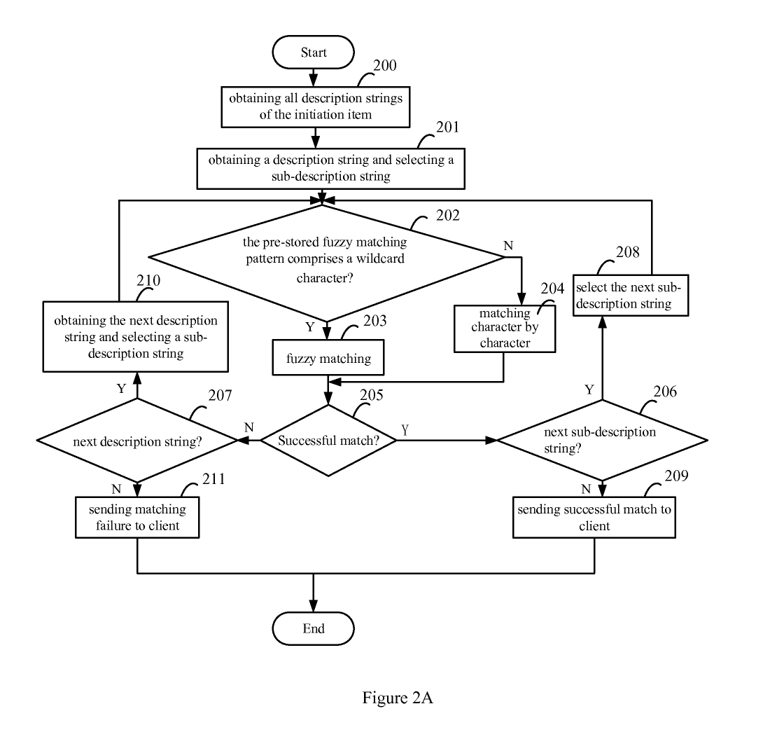

FIG. 2A is an exemplary flowchart for a method for identifying initiation items in accordance with another embodiment of the present invention, which is an improvement upon FIG. 1. As shown in FIG. 2A, the method for identifying an initiation item in this embodiment comprises steps 200-211:

Step 200: obtaining all description strings of the initiation item to be identified.

In this step, the description string of the initiation item to be identified can include the initiation item name, and the executable file name for the initiation item. For example, the initiation item name can be GoogleUpdateTaskUserS-1-5-21-690938163-3349951645-2544307016-1003UA.job; and the executable file name for the initiation item can be Googleupdate.Exe.

Step 201: obtaining a description string of the initiation item to be identified from all description strings of the initiation item to be identified; and selecting a sub-description string from the obtained description string of the initiation item to be identified; wherein the obtained description string of the initiation item to be identified comprises a plurality of sub-description strings.

In this step, if the description string of the initiation item to be identified includes the initiation item name and the executable file name for the initiation item, then a sub-description string of the initiation item is the initiation item name or the executable file name for the initiation item. If the initiation item name in the selected description string of the initiation item is GoogleUpdateTaskUserS-1-5-21-690938163-3349951645-2544307016-1003UA.job, and the executable file name for the initiation item is Googleupdate.Exe, then the selected sub-description string can be the initiation item name.

Step 202: determining if the pre-stored fuzzy matching pattern for the description string of the initiation item comprises a wildcard character; and if so, proceeding to step 203; otherwise, proceeding to step 204.

In this step, the wildcard characters include, for example, “*”, “?”, “#”, “@”, “<”, “>” and other special symbols.

Step 203: matching the obtained sub-description string in the description string of the initiation item to be identified with a pre-stored fuzzy matching pattern for the description string of the initiation item in accordance with a preset matching rule.

In this step, the pre-stored fuzzy matching pattern for the description string of the initiation item can include the following four patterns:

1) SV pattern: for example, for two different description strings of the same initiation item, “QQPCTray_v1” and “QQPCTray_v2”, S can be a string starting from the first character and ending with any character of “QQPCTray_v”, while V can be the remaining characters in the string. One of the SV patterns can be “QQPCTray_v*”, where * stands for any characters.

2) VS patterns: for example, for two different description strings of the same initiation item, “Old_QQPCTray” and “New_QQPCTray”, S can be a string starting from the first character and ending with any character of “QQPCTray”, while V can be the remaining characters in the string. One of the VS patterns can be “*_QQPCTray”, where * stands for any characters.

3) S1VS2 pattern: for example, for two different description strings of the same initiation item, “QQPCTray2009.exe” and “QQPCTray2010.exe”, S1 can be a string starting from the first character and ending with any character of “QQPCTray20”, S2 can be a string starting from the first character and ending with any character of “.exe”, while V can be the remaining characters in the string. One of the S1VS2 patterns can be “QQPCTray20*.exe”, wherein * stands for any characters.

4) V1SV2 pattern: for example, for two different description strings of the same initiation item, “Old_QQPCTray_v1” and “New_QQPCTray_v2”, S can be a string starting from the first character and ending with any character of “QQPCTray_v”; while V1 can be the remaining characters in the string before S, and V2 can be the remaining characters in the string after S. One of the V1SV2 patterns can be “*_QQPCTray_v*”, wherein * stands for any characters.

In the four patterns, S represents the identical portion of two different description strings of the same initiation item (not case-sensitive); V represents the different or variable portion of two different description strings of the same initiation item; and if there are multiple number of S or V, they will be indicated by appending a number, such as S1, S2. In implementation, the variable portion V of two different description strings of the same initiation item can also be represented using a special symbol, such as “*”, “?”, “#”, “@”, “<”, “>”. The variable portion V can also be an empty string, so that the SV and VS patterns can also be represented as V1SV2 pattern.

In accordance with a preset matching rule, the obtained description string of the initiation item to be identified is matched with all the fuzzy matching patterns discussed above. The implementation details of the matching method will be discussed later in connection with FIG. 2B.

Step 204: matching the obtained sub-description string in the description string of the initiation item to be identified with the pre-stored fuzzy matching pattern for the description string of the initiation item character-by-character.

In this step, each character in the obtained sub-description string in the description string of the initiation item to be identified is matched with each character in the pre-stored fuzzy matching pattern for the description string of the initiation item.

Step 205: determining if there is a successful match; if there is a successful match, proceeding to step 206; and if there is no successful match, proceeding to step 207.

In this step, in matching character-by-character, if each character in the obtained sub-description string in the description string of the initiation item to be identified is the same as each character in the pre-stored fuzzy matching pattern, then there is a successful match; if any character in the obtained sub-description string in the description string of the initiation item to be identified is not the same as any character in the pre-stored fuzzy matching pattern, then there is no successful match. In matching based a present matching rule, if the obtained description string of the initiation item to be identified matches with any of the fuzzy matching patterns above, then there is a successful match; on the other hand, if the obtained description string of the initiation item to be identified does not match with any of the fuzzy matching patterns above, then there is a match failure.

Step 206: determining whether the sub-description string of the obtained description string of the initiation item to be identified comprises a next sub-description string; and if so, proceeding to step 208; otherwise, proceeding to step 209.

In this step, if the initiation item name in the description string of the initiation item to be identified is GoogleUpdateTaskUserS-1-5-21-690938163-3349951645-2544307016-1003UA.job, and the executable file name for the initiation item is Googleupdate.Exe, the selected sub-description string in Step 201 is the initiation item name, then the next sub-description string in this step is the executable file nameGoogleupdate.Exe

Step 207: determining if there is a next description string of the initiation item to be identified; and if so, proceeding to step 210; otherwise, proceeding to step 211.

Step 208: selecting the next sub-description string from the obtained description string of the initiation item to be identified, and proceeding to step 202.

Step 209: if there is a successful match, identifying the obtained description string of the initiation item to be identified with the selected fuzzy matching pattern.

In this step, if the description string of the initiation item to be identified is “abc_QQPCTray_v2009”, and one of the fuzzy matching patterns is “*_QQPCTray_v*”, then the description string matches with the fuzzy matching pattern, and the description string of the initiation item to be identified “abc_QQPCTray_v2009” is identified by the matched fuzzy matching pattern “*_QQPCTray_v*”. In another words, the obtained description string of the initiation item to be identified “abc_QQPCTray_v2009” belongs to a class that the fuzzy matching pattern “*_QQPCTray_v*” represents.

Step 209 can further comprises: if there is a successful match, sending information indicating that there is a successful match for the description string of the initiation item to a client, and storing the obtained description string for the initiation item to be identified as the matched fuzzy matching pattern.

In this step, if the obtained description string of the initiation item to be identified “abc_QQPCTray_v2009” is identified by the matched fuzzy matching pattern “*_QQPCTray_v*”, then the description string “abc_QQPCTray_v2009” is stored as “*_QQPCTray_v*”.

Table 1 includes a list of description strings of initiation items, including the names of the initiation items and the names of the executable files for the initiation items. In Table 1, the names of the initiation items on different computers are all differently (Table 1 only shows 5 initiation items, but there could be more); while the corresponding execute files are the same (Googleupdate.Exe). To identify all the initiation items on all the computers without employing the method for identifying initiation items in accordance with embodiments of the present invention, millions or more data items would need to be added to a database, which would put enormous stress on both the clients and the servers. By employing the method for identifying initiation items in accordance with embodiments of the present invention, only the common data of the initiation items would need to be stored, while the un-common data on the initiation items will be replaced with *, and one data item can represent multiple description strings of the initiation items on different machines. For example, the five (or more) initiation items in Table 1 can be stored as a new initiation item GoogleUpdateTaskUser*.job, while the executable files remain to be Googleupdate.Exe.

TABLE 1
Description Strings of Initiation Items

| Initiation Items | Executable File |
|---|---|
| GoogleUpdateTaskUserS-1-5-21- | Googleupdate.Exe |
| 690938163-3349951645-2544307016-1003UA.job | |
| GoogleUpdateTaskUserS-1-5-21- | |
| 748355470-1131543501-2196516156-1000Core.job | |
| GoogleUpdateTaskUserS-1-5-21- | |
| 748355470-1131543501-2196516156-1000UA.job | |
| GoogleUpdateTaskUserS-1-5-21- | |
| 790525478-507921405-1417001333-500Core.job | |
| GoogleUpdateTaskUserS-1-5-21- | |
| 790525478-507921405-1417001333-500UA.job | |
| . . . | |

Step 210: if there is a next description string of the initiation item, obtaining the next description string of the initiation item to be identified from all description strings of the initiation item to be identified; selecting a sub-description string from the obtained description string of the initiation item to be identified; and proceeding to step 202.

Step 211: if there is a matching failure, sending information indicating that there is a matching failure for the description string of the initiation item to a client, and storing the description string of the initiation item for which there is a matching failure.

In accordance with this embodiment, the obtained description string of the initiation item to be identified is matched with a pre-stored fuzzy matching pattern for the description string of the initiation item in accordance with a preset matching rule to determine whether there is a successful match; and if there is a successful match, the obtained description string of the initiation item to be identified is identified with the matched fuzzy matching pattern. Thus, various initiation items can be identified using one fuzzy matching pattern, which enhances the identification of the initiation items and speed up the matching of initiation items. The descriptions of the initiation items can be timely obtained to enhance user experiences. Furthermore, the size of the configuration file in the boot acceleration module storing the initiation items can be reduced, the speed of reading the initiation items can be increased, and accurate descriptions of the initiation items can be provided to users to help user keep necessary initiation items and remove initiation items with bad reviews.

FIG. 2B is an exemplary flowchart for a fuzzy matching method in accordance with another embodiment of the present invention. As shown in FIG. 2B, the method for identifying an initiation item in this embodiment comprises steps 231-237:

Step 231: selecting a pre-stored fuzzy matching pattern for the description string of the initiation item.

In this step, the fuzzy matching pattern can be the SV pattern, VS pattern, S1VS2 pattern, V1SV2 pattern discussed above, or can be any other patterns defined based on the need.

Step 232: matching the obtained description string of the initiation item to be identified with the selected pre-stored fuzzy matching pattern to determine whether there is a successful match; if there is a successful match, proceeding to Step 233; if there is no successful match, proceeding to Step 235.

In this step, the obtained sub-description strings in the description string of the initiation item to be identified are matched with the selected fuzzy matching patterns. If the obtained description string of the initiation item to be identified matches with any of the fuzzy matching patterns above, then there is a successful match. On the other hand, if the obtained description string of the initiation item to be identified does not match with any of the fuzzy matching patterns above, then there is a match failure.

Step 233: if there is a successful match, identifying the obtained description string of the initiation item to be identified with the selected fuzzy matching pattern;

Step 235: if there is no successful match, determining whether there is a next fuzzy matching pattern; if a next fuzzy matching pattern, proceeding to Step 236; if there is no next fuzzy matching pattern, proceeding to step 237.

In this step, if the description string of the initiation item to be identified is “abc_QQPCTray_v2009”, and one of the fuzzy matching patterns is “*_QQPCTray_v*”, then the description string matches with the fuzzy matching pattern, and the description string of the initiation item to be identified “abc_QQPCTray_v2009” is identified by the matched fuzzy matching pattern “*_QQPCTray_v*”. In another words, the obtained description string of the initiation item to be identified “abc_QQPCTray_v2009” belongs to a class that the fuzzy matching pattern “*_QQPCTray_v*” represents.

Step 236: if there is a next fuzzy matching pattern, selecting the next fuzzy matching pattern for the description string of the initiation item, and proceeding to step 232.

Step 237: if there is no next fuzzy matching pattern, determining that there is a matching failure; and end.

In accordance with this embodiment, the obtained description string of the initiation item to be identified is matched with a pre-stored fuzzy matching pattern for the description string of the initiation item in accordance with a preset matching rule to determine whether there is a successful match; and if there is a successful match, the obtained description string of the initiation item to be identified is identified with the matched fuzzy matching pattern. Thus, various initiation items can be identified using one fuzzy matching pattern, which enhances the identification of the initiation items and speed up the matching of initiation items. The descriptions of the initiation items can be timely obtained to enhance user experiences. Furthermore, the size of the configuration file in the boot acceleration module storing the initiation items can be reduced, the speed of reading the initiation items can be increased, and accurate descriptions of the initiation items can be provided to users to help user keep necessary initiation items and remove initiation items with bad reviews.

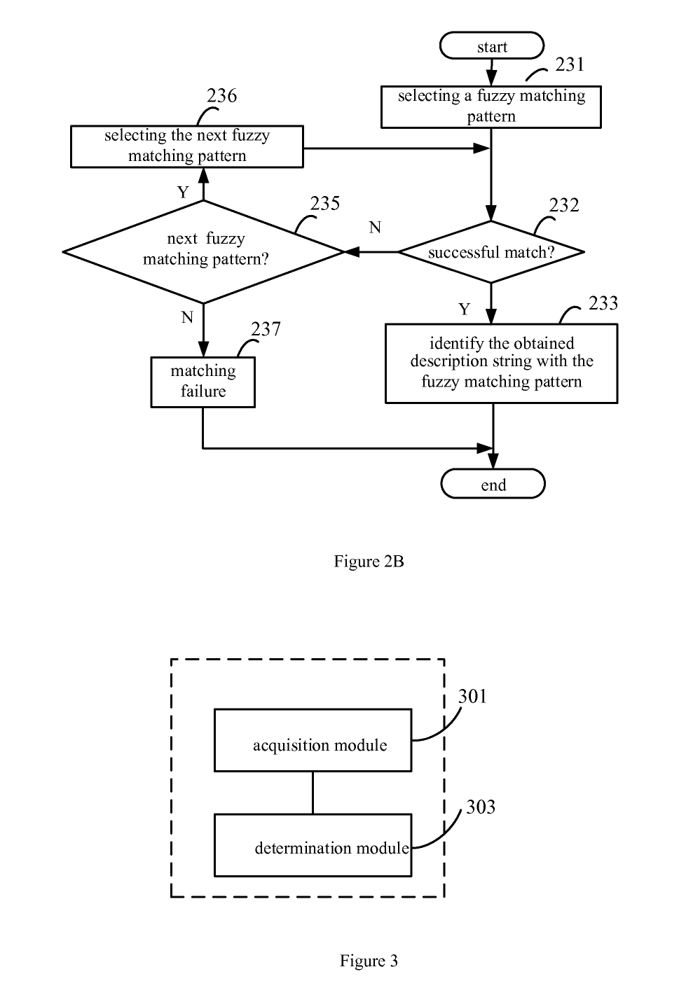

FIG. 3 is an exemplary schematic diagram for an apparatus for identifying initiation items in accordance with yet another embodiment of the present invention. As shown in FIG. 3, the apparatus for identifying initiation items comprises: an acquisition module 301 and a determination module 303.

The acquisition module 301 is used for obtaining a description string of the initiation item to be identified.

The acquisition module 301 is further used for receiving all description strings of the initiation item to be identified; obtaining a description string of the initiation item to be identified from all description strings of the initiation item to be identified; and selecting a sub-description string from the obtained description string of the initiation item to be identified, wherein the obtained description string of the initiation item to be identified comprises a plurality of sub-description strings.

The determination module 303 is used for matching the obtained description string of the initiation item to be identified with a pre-stored fuzzy matching pattern for the description string of the initiation item in accordance with a preset matching rule to determine whether there is a successful match; and, if there is a successful match, identifying the obtained description string of the initiation item to be identified with the matched fuzzy matching pattern.

The determination module 303 is further used for determining if the pre-stored fuzzy matching pattern for the description string of the initiation item comprises a wildcard character; and if the pre-stored fuzzy matching pattern for the description string of the initiation item comprises no wildcard characters, matching the obtained description string of the initiation item to be identified with the pre-stored fuzzy matching pattern for the description string of the initiation item character-by-character.

The determination module 303 is further used for determining whether the sub-description string of the obtained description string of the initiation item to be identified comprises a next sub-description string; and if so, selecting the next sub-description string from the obtained description string of the initiation item to be identified.

The determination module 303 is further used for selecting a pre-stored fuzzy matching pattern for the description string of the initiation item; matching the obtained description string of the initiation item to be identified with the selected pre-stored fuzzy matching pattern in accordance with a preset matching rule to determine whether there is a successful match; if there is a successful match, identifying the obtained description string of the initiation item to be identified with the selected fuzzy matching pattern; if there is no successful match, determining whether there is a next fuzzy matching pattern; if there is no next fuzzy matching pattern, determining that there is a matching failure; and if there is a next fuzzy matching pattern, selecting the next fuzzy matching pattern, and performing the step of matching the obtained description string of the initiation item to be identified with the selected pre-stored fuzzy matching pattern in accordance with a preset matching rule.

The determination module 303 is further used for, if there is a matching failure, sending information indicating that there is a matching failure for the description string of the initiation item to a client, and storing the description string of the initiation item for which there is a matching failure.

The determination module 303 is further used for, if there is a successful match, sending information indicating that there is a successful match for the description string of the initiation item to a client, and storing the obtained description string for the initiation item to be identified as the matched fuzzy matching pattern.

In accordance with this embodiment, the obtained description string of the initiation item to be identified is matched with a pre-stored fuzzy matching pattern for the description string of the initiation item in accordance with a preset matching rule to determine whether there is a successful match; and if there is a successful match, the obtained description string of the initiation item to be identified is identified with the matched fuzzy matching pattern. Thus, various initiation items can be identified using one fuzzy matching pattern, which enhances the identification of the initiation items and speed up the matching of initiation items. The descriptions of the initiation items can be timely obtained to enhance user experiences. Furthermore, the size of the configuration file in the boot acceleration module storing the initiation items can be reduced, the speed of reading the initiation items can be increased, and accurate descriptions of the initiation items can be provided to users to help user keep necessary initiation items and remove initiation items with bad reviews.

Those skilled in the art will understand that all or part of the embodiments of the present invention can be implemented by computer hardware, or by a computer program controlling the relevant hardware. The computer program can also be stored and/or transported within any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any medium that can contain or store the program for use by or in connection with the instruction execution system, apparatus, or device. The computer readable medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The various embodiments of the present invention are merely preferred embodiments, and are not intended to limit the scope of the present invention, which includes any modification, equivalent, or improvement that does not depart from the spirit and principles of the present invention.

1. A method for identifying an initiation item, the method comprising:
obtaining a description string of the initiation item to be identified;
matching the obtained description string of the initiation item to be identified with a pre-stored fuzzy matching pattern for the description string of the initiation item in accordance with a preset matching rule to determine whether there is a successful match; and
if there is a successful match, identifying the obtained description string of the initiation item to be identified with the matched fuzzy matching pattern.

2. The method of claim 1, further comprising, prior to the step of matching the obtained description string of the initiation item to be identified with a pre-stored fuzzy matching pattern for the description string of the initiation item in accordance with a preset matching rule:
determining if the pre-stored fuzzy matching pattern for the description string of the initiation item comprises a wildcard character; and
if the pre-stored fuzzy matching pattern for the description string of the initiation item comprises no wildcard characters, matching the obtained description string of the initiation item to be identified with the pre-stored fuzzy matching pattern for the description string of the initiation item character-by-character.

3. The method of claim 1, wherein the step of obtaining a description string of the initiation item to be identified further comprises:
receiving all description strings of the initiation item to be identified;
obtaining a description string of the initiation item to be identified from all description strings of the initiation item to be identified; and
selecting a sub-description string from the obtained description string of the initiation item to be identified;
wherein the obtained description string of the initiation item to be identified comprises a plurality of sub-description strings.

4. The method of claim 3, further comprising:
if there is a successful match, determining whether the sub-description string of the obtained description string of the initiation item to be identified comprises a next sub-description string; and if so, selecting the next sub-description string from the obtained description string of the initiation item to be identified.

5. The method of claim 1, wherein the step of matching the obtained description string of the initiation item to be identified with a pre-stored fuzzy matching pattern for the description string of the initiation item in accordance with a preset matching rule further comprises:
selecting a pre-stored fuzzy matching pattern for the description string of the initiation item;
matching the obtained description string of the initiation item to be identified with the selected pre-stored fuzzy matching pattern in accordance with a preset matching rule to determine whether there is a successful match;
if there is a successful match, identifying the obtained description string of the initiation item to be identified with the selected fuzzy matching pattern;
if there is no successful match, determining whether there is a next fuzzy matching pattern;
if there is no next fuzzy matching pattern, determining that there is a matching failure; and
if there is a next fuzzy matching pattern, selecting the next fuzzy matching pattern, and performing the step of matching the obtained description string of the initiation item to be identified with the selected pre-stored fuzzy matching pattern in accordance with a preset matching rule.

6. The method of claim 1, further comprising:
if there is a matching failure, sending information indicating that there is a matching failure for the description string of the initiation item to a client, and storing the description string of the initiation item for which there is a matching failure.

7. The method of claim 1, further comprising:
if there is a successful match, sending information indicating that there is a successful match for the description string of the initiation item to a client, and storing the obtained description string for the initiation item to be identified as the matched fuzzy matching pattern.

8. An apparatus for identifying an initiation item, comprising:
an acquisition module for obtaining a description string of the initiation item to be identified; and
a determination module for matching the obtained description string of the initiation item to be identified with a pre-stored fuzzy matching pattern for the description string of the initiation item in accordance with a preset matching rule to determine whether there is a successful match; and, if there is a successful match, identifying the obtained description string of the initiation item to be identified with the matched fuzzy matching pattern.

9. The apparatus of claim 8, wherein the determination module is further configured for determining if the pre-stored fuzzy matching pattern for the description string of the initiation item comprises a wildcard character; and if the pre-stored fuzzy matching pattern for the description string of the initiation item comprises no wildcard characters, matching the obtained description string of the initiation item to be identified with the pre-stored fuzzy matching pattern for the description string of the initiation item character-by-character.

10. The apparatus of claim 8, wherein the acquisition module is further configured for:
receiving all description strings of the initiation item to be identified;
obtaining a description string of the initiation item to be identified from all description strings of the initiation item to be identified comprising a plurality of sub-description strings; and
selecting a sub-description string from the obtained description string of the initiation item to be identified;
wherein the obtained description string of the initiation item to be identified comprises a plurality of sub-description strings.

11. The apparatus of claim 10, wherein the determination module is further configured for:
determining whether the sub-description string of the obtained description string of the initiation item to be identified comprises a next sub-description string; and if so, selecting the next sub-description string from the obtained description string of the initiation item to be identified.

12. The apparatus of claim 8, wherein the determination module is further configured for:
selecting a pre-stored fuzzy matching pattern for the description string of the initiation item;
matching the obtained description string of the initiation item to be identified with the selected pre-stored fuzzy matching pattern in accordance with a preset matching rule to determine whether there is a successful match;
if there is a successful match, identifying the obtained description string of the initiation item to be identified with the selected fuzzy matching pattern;
if there is no successful match, determining whether there is a next fuzzy matching pattern;
if there is no next fuzzy matching pattern, determining that there is a matching failure; and
if there is a next fuzzy matching pattern, selecting the next fuzzy matching pattern, and performing the step of matching the obtained description string of the initiation item to be identified with the selected pre-stored fuzzy matching pattern in accordance with a preset matching rule.

13. The apparatus of claim 8, wherein the determination module is further configured for:
if there is a matching failure, sending information indicating that there is a matching failure for the description string of the initiation item to a client, and storing the description string of the initiation item for which there is a matching failure.

14. The apparatus of claim 8, wherein the determination module is further configured for:
if there is a successful match, sending information indicating that there is a successful match for the description string of the initiation item to a client, and storing the obtained description string for the initiation item to be identified as the matched fuzzy matching pattern.

15. A computer-readable medium having stored thereon computer-executable instructions, said computer-executable instructions for performing a method for identifying an initiation item, the method comprising:
obtaining a description string of the initiation item to be identified;
selecting a pre-stored fuzzy matching pattern;
matching the obtained description string with the selected fuzzy matching pattern in accordance with a preset matching rule to determine whether there is a successful match; and
if there is a successful match, identifying the obtained description string with the matched fuzzy matching pattern.

16. The computer-readable medium of claim 15, wherein the method further comprises:
if the selected fuzzy matching pattern comprises no wildcard characters, matching the obtained description string with the selected fuzzy matching pattern character-by-character.

17. The computer-readable medium of claim 15, wherein the description string of the initiation item comprises the name of a task that a client executes upon being started.

18. The computer-readable medium of claim 15, wherein the description string of the initiation item comprises the name of an application program that a client executes upon being started.

19. The computer-readable medium of claim 15, wherein the fuzzy matching pattern is pre-stored on a server.

20. The computer-readable medium of claim 15, wherein the method is being executed by a server to control the startup of a client.

21. The computer-readable medium of claim 15, the method further comprises:
if there is no successful match, determining whether there is a next fuzzy matching pattern; and
if there is no next fuzzy matching pattern, determining that there is a matching failure.

22. The computer-readable medium of claim 19, the method further comprises:
if there is a matching failure, storing the description string.
